(19) United States
(12) Patent Application Publication
(10) Pub. No.: US 2009/0208445 A1
(43) Pub. Date: Aug. 20, 2009

(54) Compositions Comprising Eucalyptol And/Or Ocimene And/Or Farnesol For Use As Bumblebee Pheromones

(75) Inventors: Anna Dornhaus, Tucson, AZ (US); Francisco J. Egea Gonzalez, Almeria (ES); Angela Mena Granero, Almeria (ES); Jose Manuel Guerra Sanz, Almeria (SE); Anna Roldan Serrano, Almeria (SE); Jose Luis Martinez Vidal, Almeria (ES); Lars Chittka, London (GB)

Correspondence Address: Pepper Hamilton LLP, 400 Berwyn Park, 899 Cassatt Road, Berwyn, PA, 19312-1183, US

(73) Assignee: QUEEN MARY & WESTFIELD COLLEGE, London (GB)

(21) Appl. No.: 11/917,576

(22) PCT Filed: Jun. 16, 2006
(86) PCT No.: PCT/GB06/02206

§ 371 Date: Jan. 7, 2009

(30) Foreign Application Priority Data
Jun. 16, 2005 (GB) 0512325.2

(51) Int. Cl. A01N 25/00; A01P 19/00

(52) U.S. Cl. 424/84

(57) ABSTRACT

Compositions comprising eucalyptol and/or ocimene and/or farnesol are provided for use as bumblebee pheromones. The compositions are useful in agriculture to assist in the pollination of angiosperm plant species. Such compositions can attract insects of the genus Bombus (bumblebee) to angiosperm plants where the composition is applied to the plant, or to the environment of the plant.

The present invention relates to chemical compounds useful in modulation of the behaviour of bumblebees, specifically pheromones which can be used to mimic the natural foraging recruitment pheromone.

It is well known that bees are needed to pollinate crops and plants but it is probably less well known or appreciated that the economic value of bee pollination is several times greater than the value of the world-wide production of honey. About 80% of agricultural food crops are pollinated by animal pollinators, which are in the main bees. It is estimated that one third of human food and drink consumption can be traced back to plants which are pollinated through service supplied by pollinators.

A majority of angiosperm or flowering plants depend for pollination on animals, which in the main are insects, for example flies (Diptera), beetles (Coleoptera), butterflies (Lepidoptera), but most important, bees (Hymenoptera: Apoidea). In view of their morphological adaptations for the collection of pollen, bees are considered to be the most efficient pollinators. In particular, it is the social bees which live in permanent “colonies”; of the taxonomic groups Apini/“Honeybees”, Meliponini/“Stingless bees” and Bombini/“Bumblebees” that are most important as flower visitors and pollinators which is due to the existence of their long-lived colonies. In order to survive, a typical bee colony needs to exploit a range of food sources at any time of the year. No single food source will be available throughout the year, therefore the relatively short-lived foraging honeybees do not have a genetically determined flower preference, as is the case in many solitary bee species. Instead, individual honeybees develop their own foraging specialization in the field, following the local and temporal availability of various flowers and other information obtained.

Honeybees are generalists at colony level, but to a large extent flower specialists at an individual level. Certain groups of bees are able to perform specialized pollen collecting behavior, so-called “buzz-pollination”. In a wide range of angiosperm families, pollen can only be released when the stamens are shaken by vibrating bees. This buzz-pollination is performed by bumblebees, carpenter bees and by stingless bees of the genus Melipona, but not by honeybees. The recent development in the use of bumblebees in the applied pollination of tomato and sweet pepper shows the advantages of the use of a buzz-pollinator. The world wide value of sold bumblebee colonies (estimated at around 1,000,000 colonies/yr) is around US$100 million (APIMONDIA Standing Commission for Pollination and Bee Flora Bee Research Department, Utrecht University, www.bio.uu.nl/˜sommeijer/apimondia.html).

Bumblebees do not communicate spatial co-ordinates of food sources as honey bees do with the waggle dance, but successful bumblebee foragers do inform nest mates about the general availability and the scent of rewarding food sources (Dornhaus and Chittka 1999, 2001). This helps recruits to avoid searching for food when foraging conditions are unfavourable, as well as aiding in the discovery of rewarding flowers, which bees can recognize by the scent they have learned while in the nest. Successful bumblebee foragers, when returning to the colony, often show a curious behaviour consisting of excited runs with bouts of wing-fanning. The reaction shown by previously unemployed bees in the nest is to become active, i.e. to show increased movement speeds and leave the nest in search for food (Dornhaus and Chittka 2001). Behavioural tests have clearly shown that this communication is mediated by a pheromone (Dornhaus et al. 2003), but the chemical nature of this pheromone has not yet been identified.

The production of many agricultural crops is now undertaken in enclosed environments such as greenhouses where the plants need to be pollinated in the absence of natural pollinators. Many such plants are those which depend upon the use of “buzz-pollination” and as a result bumblebees are deliberately introduced on a commercial scale to achieve this goal. However, the use of bumblebees in such an environment does not guarantee success and neither is the process as efficient as it might be. There is therefore a need for a composition that could act as an attractant or recruitment pheromone to cause the bumblebees to pollinate the plants where pollination is required.

According to a first aspect of the invention, there is provided a composition comprising eucalyptol, ocimene and farnesol.

Eucalyptol is also known as 1,8-epoxy-p-menthane, or 1,8-Cineole, or 1,3,3-Trimethyl-2-oxabicyclo[2.2.2.]octane and has the empirical formula: C₁₀H₁₈O, represented by the molecular formula:

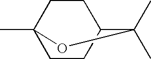

A composition of the present invention therefore includes eucalyptol as defined above, a derivative, variant or isomer thereof.

Farnesol includes isomers of farnesol such as E,E-farnesol, and Z,E-farnesol. Farnesol is also referred to as 3,7,11-trimethyl-2,6,10-dodecatrien-1-ol, or t,t-Farnesol and has the empirical formula C₁₅H₂₆O, represented by the molecular formula:

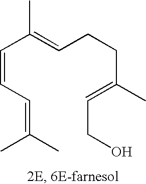

A composition of the present invention therefore includes farnesol as defined above, a derivative, variant or isomer thereof.

Ocimene includes isomers such as trans-beta-ocimene, trans-alpha-ocimene, cis-beta-ocimene and cis-alpha-ocimene. Ocimene is also referred to as 3,7-dimethyl-1,3,6-octatriene and has the empirical formula C₁₀H₁₆, represented by the molecular formula:

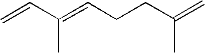

A composition of the present invention therefore includes ocimene as defined above, a derivative, variant or isomer thereof.

Derivatives or variants include molecules having the same or similar functional activity as the above molecules which may be optionally substituted with one or more groups within the routine skill of the person skilled in the art. Such as, for example, the addition or removal of a hydroxyl group (—OH), oxidation of a hydroxyl group to the corresponding aldehyde or ketone.

Other volatile compounds may be included in the composition as desired, such as one or more of linalool, alpha-pinene, beta-pinene, ethylbenzene, p-xylene and/or m-xyelene, or an isomer or a derivative thereof.

The components of the composition may be formulated as desired in an acceptable diluent and/or excipient if required. The formulation may be prepared in an aqueous or an non-aqueous medium as desired. It may be an emulsion or a microemulsion. The composition may be prepared as a liposomal formulation.

The compositions of the invention may be adapted for administration to a bee hive, bee colony, and/or bee nest, or for administration to plants or for administration to the environment surrounding plants, particularly in the case of plants being cultivated in an enclosed space, such as a greenhouse or other such indoor environment which is not directly or constantly exposed to external ambient conditions. However, it is also envisaged that the compositions of the invention may equally be used in exposed environments under ambient conditions.

The bee hive may be a bee hive that is traditionally used for agricultural purposes, but the term equally applies to any organised structure used for farming bees to obtain honey from bees, or for the purposes of plant pollination by bees.

According to a second aspect of the invention, there is provided an agrochemical composition comprising eucalyptol, and/or ocimene and/or farnesol. The agrochemical composition may be formulated for administration to plants, suitably a plant of an angiosperm plant species. The composition may comprise one or more of eucalyptol, ocimene or farnesol.

As discussed above, the compositions of the invention may be adapted for administration to a bee colony, such as a bee hive or bee nest, however, the compositions may also be prepared as agrochemical compositions formulated for administration to plants. The composition may also be formulated for administration to the environment of the plants.

According to a third aspect of the invention, there is provided a composition according to the first aspect or second aspect for use in pollination of a plant of an angiosperm plant species. Such uses include a method of pollination of a plant of an angiosperm plant species, comprising administering said composition to an angiosperm plant in need of pollination or administration of the composition to the environment of said plant.

The angiosperm plant species may be, but is not limited to, tomato (Lypersicon esculentum), courgette/zucchini (Cucurbita pepo), pumpkin/squash (Curcurbita pepo), cucumber (Cucumis sativus), strawberry Fragaria spec. (for example Fragaria vesca), egg plant/aubergine (Solanum melongena), melon (Cucumis melo), pepper (Capsicum annuum), sweet pepper (Capsicum annuum), blueberry (Vaccinum myritillus), apricot (Prunus armeniaca), almond (Prunus dulcis), apple (Malus domestica), cranberry (Vaccinum vitis-idaea), raspberry (Rubus idaeus), red currant (Ribes rubrum), black currant (Ribes nigrumi), cherry (Prunus spec) for example Prunus padus)) peach (Prunus persica), pear (Pyrus pyraster), or plum (Prunus doiiiestica).

Particularly, preferred species include angiosperm plants such as tomato, courgette, cucumber, strawberry, egg plant, melon, pepper, sweet pepper, blueberry, apricot, almond, apple, cranberry, raspberry, red currant, black currant, cherry, peach, pear and plum.

Pollination is the process of transfer of a pollen grains (the male plant gametes) to the plant carpel, the structure that contains the ovule (the female plant gamete). The receptive part of the carpel is called a Stigfla in the flowers of angiosperm plants. Pollination is therefore an important step in the reproduction of seed plants. Pollination is important in horticulture because plant fruits will not develop if the ovules are not fertilized. The process of pollination requires the presence of a pollinator as an agent to carry or move the pollen grains from the anther to the receptive part of the carpel. According to the present invention, the pollinator of choice is an insect of the genus Bombus, known informally as a bumblebee. Pollination of plants by insects is also known as entomophily.

Pollination of plants by bumblebees is achieved by “buzz-pollination”. Typically, bees collect pollen (as a food) when they land in the inner area of a flower. Pollen is produced in flowering plants in organs called anthers. In many plants, the pollen in the anther is accessible, but in certain plants (such as the eggplant) it's relatively inaccessible, because the anthers are tubular with an opening on only one end. As a consequence, release of the pollen requires an additional effort on the part of the bee.

When a bee lands on the flower it clings onto the flower and thereby tips the flower over and makes a buzzing sound that is very intense. The bee is using its indirect flight muscles to cause a vibration which liberates the pollen grains which are held in the pollen tube after which the grains are released.

The noise of a bumblebee involved in buzz pollination is therefore different and distinct to the noise of a bee in flight as the action of the wings is different. In buzz pollination, the wings are not moved, but the indirect flight muscles are vibrated so as to dislodge the pollen grains.

References herein to pollination of a plant include pollination of an individual flower on said plant.

Administration of the composition to the plant or to the environment of the plant may comprise any suitable means, such as spraying, misting, or painting of the composition onto the plant or surrounding area. The composition may be administered systemically to the plant, or directed onto a certain area of the plant, such as the flowers, stalks and/or leaves. The composition may be administered as an aerosol. Administration of the composition to the environment of the plant may include administration into the atmosphere (by means of periodic or constant delivery of the composition, or from a delayed-release or controlled-release substrate), or alternatively administration to one or more locations surrounding the plant. Delayed-release means may rely on physical processes such as evaporation from a porous substrate, or on chemical processes such as release from a wax, gel, or polymer that slowly release the composition over a period of time in response to moisture or exposure to the atmosphere.

According to a fourth aspect of the invention, there is provided a method for attracting an insect of the genus Bombus to an angiosperm plant, comprising administering a composition of the first aspect or second aspect to the plant. Such methods may also comprise administration of the compositions of the invention to the environment of the plant

The attraction of the insect to the plant may conveniently result in the insect visiting the flowers of the plant. The action of the insect visiting the flowers of the plant may conveniently cause pollination of the plant. The insect of the genus Bombus may be a bumblebee of the species including, but not limited to, Bombus terrestris, Bombus impatients, Bombus occidentalis, Bombus canariensis, Bombus ignitus, Bombus hypocrita, Bombus diversus.

According to a fifth aspect of the invention, there is provided a method for causing an insect of the genus Bombus to leave a colony of said insects, comprising administration of a composition as defined above to the colony.

A colony of insects of the genus Bombus may be a temporary grouping of at least two such insects, although typically a colony will represent a much greater number of individual insects, such as, for example 80 to 100 insects. The colony may be in a hive, which maybe purpose-built for the purposes of farming the insects, or it may a nest.

Administration of the compositions of the present invention is believed to be understood by the insects as a stimulus to forage for food. The search for food by such insects typically involves the visit of the insect to nectar-beating flowers of angiosperm plants and contact of the insect with the flower of the plant typically results in pollination of the plant.

According to a sixth aspect of the invention, there is provided a kit of parts comprising eucalyptol, ocimene and farnesol for separate, simultaneous or subsequent administration to a plant of an angiosperm plant species. This aspect of the invention therefore also extends to a method of pollination of a plant of an angiosperm plant species comprising the separate, simultaneous or subsequent administration of eucalyptol, ocimene and farnesol to said plant.

According to a seventh aspect of the invention, there is provided a kit for the pollination of an angiosperm plant comprising a composition of the first aspect or second aspect defined above, or a kit of parts of the fifth aspect. Suitably, the kit may contain instructions for use in a method as described above. The kit may additionally comprise an insect of the genus Bombus.

In a preferred embodiment of the invention, there is provided a method for the pollination of a plant of an angiosperm plant species, comprising administration of a composition comprising eucalyptol, ocimene and farnesol to a plant of the angiosperm plant species or to the immediate environment of the plant, such that the composition attracts an insect of the genus Bombus to the flowers of the plant which results in pollination of the flower.

In an alternative preferred embodiment of the invention, there is provided a method for the attraction of an insect of the genus Bombus to a plant of an angiosperm plant species, comprising administration of a composition comprising eucalyptol, ocimene and farnesol to the plant or to the immediate environment of the plant, such that the composition attracts an insect of the genus Bombus to the flowers of the plant which suitably results in pollination of the flower.

The present invention also usefully provides a method for causing an insect of the genus Bombus to leave a colony of said insects, comprising administration of a composition as defined above to the colony. Suitably, the insect when caused to leave the colony may visit a flower of a plant of an angiosperm plant species so as to result in the pollination of said flower.

Still further embodiments of the invention, provide such methods as described above in which the composition is applied to a plant or its environment and wherein the composition comprises a substance selected from the group consisting of eucalyptol, ocimene and farnesol.

Preferred features for the second and subsequent aspects of the invention are as for the first aspect mutatis mutandis.

The invention will now be further described by way of reference to the following Examples and Figures which are provided for the purposes of illustration only and are not to be construed as being limiting on the invention. Reference is made to a number of Figures in which:

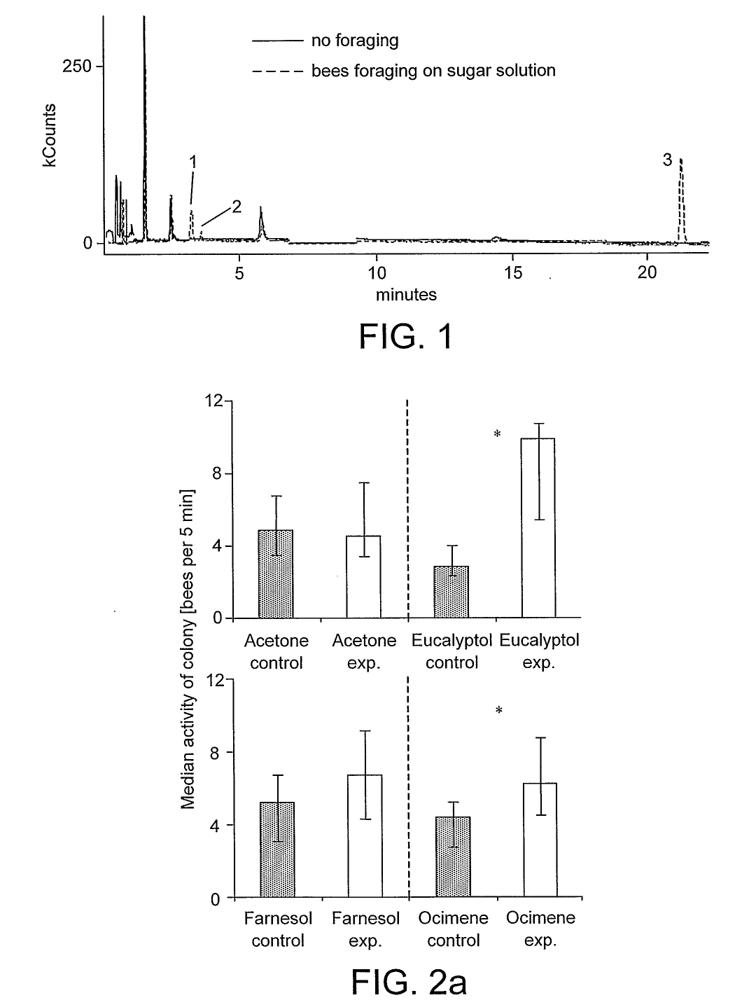

FIG. 1 shows chromatograms of air samples taken from the bumblebee nest box before (continuous line) and during (dotted line) foraging. Peaks 1 (eucalyptol), 2 (ocimene) and 3 (farnesol) are present only when successful foragers return from the feeder.

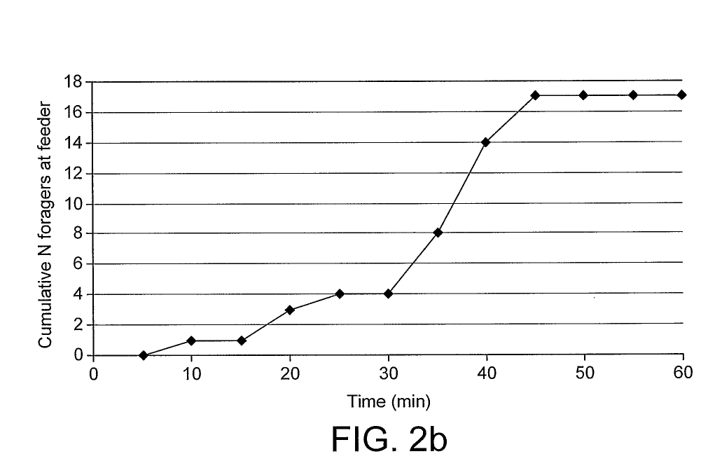

FIG. 2 shows (a) effects of pheromone compounds on numbers of foragers leaving the nest in search for food. Foragers leaving the nest were counted over 5 min intervals in the 30 minutes preceding the introduction of the compound, and 30 min after its introduction. Black bars—before foraging; white bars—during foraging; and (b) Cumulative number of identified foragers that landed on a feeder in the flight arena before (0-30 min) and after (30-60 min) the insertion of eucalyptol into the nest box. Total number of foragers in the colony was 17.

### EXAMPLES

### Materials and Methods

All experiments were performed with lab-reared colonies of Bombus terrestris with 30-50 workers. A total of ten colonies were used. Each nest was contained in a wooden box (26 cm·14 cm·10 cm), which was connected to a foraging arena (40 cm·60 cm·30 cm) with a Plexiglas tube of 30 cm length. Nest box and foraging arena had transparent Plexiglas covers, so that the behaviour of the bees could be observed. The arena contained a feeder at certain times of the experiment (see below).

### a) Chemicals and Reagents

All reference standards and the internal standard (IS), were of analytical grade and were purchased from Sigma-Aldrich (St. Louis, Mo., USA) or Tokyo Kasei (Nihonbashi, Tokyo, Japan), the internal standard being deuterated p-xylene (p-xylene-d10). A reference standard solution was prepared for each compound using acetone as solvent at 200 μg ml⁻¹ concentration. A multicompound working standard solution (20 μg ml⁻¹ concentration) was prepared from the above by appropriate dilution with acetone and stored under refrigeration (4° C.). Organic solvents of chromatographic grade were obtained from Panreac (Barcelona, Spain). The syringe injector of the SPMB unit (Supelco, USA), equipped with 65 μm polydimethylsiloxane-divinylbenzene (PDMS-DVB) fibres (Supelco, USA), was used for the extraction procedure. Fibres were conditioned prior to use according to supplier's prescriptions.

### b) Apparatus

GC-MS analysis was performed with a Varian 3800 gas chromatograph with Electronic Flow Control (EFC) and fitted with a Saturn 2000 ion-trap mass spectrometer (Varian Instruments, Sunnyvale, Calif., USA). Samples were injected with a Varian 8200 auto sampler with a syringe injector of the SPME unit (Supelco, USA) into an SPI/1079 split/splitless programmed-temperature injector. A Rapid-MS (WCOT fused silica CP-Sil 8 CB low bleed (5% phenyl, 95% dimethylpolysiloxane) of 10 m×0.53 mm i.d.×0.25 μm film thickness) analytical column from Varian Instruments (Sunnyvale, Calif., USA) was used for high speed analysis. The mass spectrometer was operated in Electron Impact (EI). The controlling computer system had an EI-MS/MS library specially created for the target analytes under these experimental conditions. Other EI-MS libraries were also available. The mass spectrometer was calibrated weekly with perfluorotributylamine. Helium (99.999%) at a flow rate of 1 ml/min was used as carrier and collision gas.

### c) Laboratory Trial Design for Pheromone Analysis

The insects were not fed during two days before the experiments. During tests, bees were fed by placing a dish filled with a feeder with a 73% (volume) sugar solution (sucrose 30%, dextrose 31% and fructose 39% of dry mass) into the arena for 120 min. The airspace was sampled above the colony while foragers were returning from the food source and performing their irregular runs on the comb. This was repeated 10 times with at least 3 h intervals between trials. As controls, the colony airspace was also sampled before each feeding had begun.

HS-SPME (Headspace-Solid Phase Microextraction) conditions were established for validating the analytical method as follows. The performance of the method was assessed calculating linear ranges, recovery rates, precision and lower limits (Mena et al. 2004). For calibration purposes, three empty boxes with the same dimensions as the nest box previously described were spiked with appropriate volumes of the 20 mg 1⁻¹ standard mixture containing all the analytes. Linear ranges were assessed in analyte amounts between 100 and 5000 ng; recovery rates and precision were determined at two amount rates, 100 and 500 ng of each analyte, the spiked boxes being sampled during 1, 2 and 3 hours, in order to check whether the equilibrium into the atmosphere of the boxes was reached; precision was obtained checking the standard deviation of 10 replicates of recovery experiments. Finally, lower limits were obtained by sampling boxes spiked with decreasing volumes of the standard solution mixture. This was performed with 3 replicates, until the recovery rates yielded unacceptably high standard deviations.

Once the compounds were concentrated on the fibre, they were desorbed directly into the injection port of the Varian 3800 gas chromatograph using an autosampler at 250° C. The initial column temperature was set at 35° C. during injection, 9 min hold, then increased at 1.5° C. min⁻¹ to 55° C., at 3° C. min⁻¹ to 65° C., 2 min held, and finally raised to 300° C. at 100° C. min⁻¹ that was held for 5 min. Earlier tests had identified clusters of gland cells attached to the tergites of bumblebee workers to be the source of the alerting pheromone (Dornhaus et al. 2003). Five foragers that had just returned to the nest from the feeder were dissected, and the compounds found in extracts of their tergites (containing such glands) were compared with those from 5 foragers that had not been offered food. Samples of tergites were put in 10 ml headspace vials for analysis, capped with a screw cap and a PTFE/silicone septa, being sampled during 15 min with one fibre inserted through the septum. The identification of pheromones was performed by MS/MS detection mode.

### d) Quantification of Behavioural Effects

Since three compounds were found to be most likely candidates for being components of the food alerting pheromone (see below), the behavioural effects of these compounds (eucalyptol, E,E-farnesol, and Z-ocimene) was tested on forager recruitment. To this end, 10 μl of solution of the individual compounds at 200 mg 1⁻¹ acetone, were dispensed onto a filter paper placed in a glass tube in the lid of the nest box. This was repeated every 5 minutes for half an hour, and numbers of foragers entering the flight arena in search for food were counted in 5 min intervals during the experimental half hour and in the preceding 30 min (control period). This experiment was repeated 7 times which each individual compound. In addition, 7 control runs were performed with acetone, to exclude the possibility that the solvent itself provoked a behavioural response. Tests were done in random sequence with three bumblebee colonies, with at least 4 h between tests on a single colony. None of the compounds were tested twice on the same day with the same colony.

Finally, an experiment was designed to investigate the percentage of the total forager force of a bumblebee colony that could be mobilised by the chemical which turned out to be the most potent, eucalyptol (see below). To this end, all foragers were marked that arrived at an ad libitum sucrose feeder in a flight arena connected to a large nest (with >80 workers), over a period of two days. Bees were given individual number plates (Opalith). Then the colony was starved for 1 day, and on the next day, a sucrose feeder was inserted into the arena for one hour. After 30 min, the colony was exposed to eucalyptol as described above. Bees were caught immediately upon arrival, so that they could not provide feedback to the colony.

Within the nest box, it was found that three substances were not quantifiable while bees did not forage, but increased highly significantly during foraging (Table 1, FIG. 1); these were eucalyptol, ocimene, and farnesol (Wilcoxon-test, n=10 pairs, T=0, Z=2.803, p<0.005 in all three cases). Some other volatiles, which were already present before foraging, changed significantly during foraging: these were linalool (n=10 pairs, T=8, Z=1.987, p=0.046), α- and β-pinene (n=10 pairs, T=4, Z=2.395, p=0.016), which were quantified as sum of two isomers, and ethylbenzene, p-xylene and m-xylene (n=10 pairs, T=3, Z=2.497, p=0.012), which were quantified together because they overlapped in one chromatographic peak (Table 1). In the tergal segments, however, statistically significant differences were found only in three compounds, ocimene (One way ANOVA, F=25.54, df=1, p<0.001), eucalyptol (F=107.3, df=1, p<0.001) and farnesol (F=20.62, df=1, p=0.002), which could only be quantified during foraging. Previous studies have identified the tergal glands as the source of the alerting pheromone (Dornhaus et al. 2003). Hence it was conjectured that these three volatiles might be especially important in foraging recruitment, and tested their effects on food recruitment directly.

Table 1 shows the following data. Amount of volatiles in nanograms (average+/−SE). Wilcoxon tests were carried out comparing the samples of the box, before and during feeding. One way ANOVA was used to compare the tergites before and during feeding, since the dissection of foragers did not allow to collect paired data as in the nest box samples. Statistical significance between samples is indicated by asterisks (*p<0.05; **p<0.01; ***p<0.001). LOQ: limit of quantification. The following substances were also evaluated, but were consistently <LOQ: Benzene, o-xylene, 3-carene, 1,4-dimethoxybenzene, citral, p-anisaldehyde, cinnamaldehyde, indole, cinnamyl alcohol, dibuthyl phthalate, eugenol, 1,2,4-trimethoxybenzene, geranyl acetate, geranic acid.

TABLE 1

| | Nest | Nest | Tergites | Tergites |
|---|---|---|---|---|
| | before | during | before | during |
| Compound | foraging | foraging | foraging | foraging |
| Toluene | 920.8 ± 114.3 | 912.1 ± 353.3 | 453.2 ± 143.4 | 624.4 ± 270.6 |
| Ethylbezene, p- | 458.7 ± 86.1* | 978.6 ± 445.2 | 649.0 ± 159.5 | 575.8 ± 159.4 |
| xylene, m-xylene | | | | |
| [Alpha]-pinene + | 1807.6 ± 620.2* | 1192.4 ± 578.0 | 748.6 ± 191.8 | 648.8 ± 220.9 |
| [beta]-pinene | | | | |
| Myrcene | 991.3 ± 650.7 | 976.5 ± 471.2 | 546.4 ± 126.8 | 627.4 ± 241.7 |
| (R)-(+)-Limonene + | 104.0 ± 93.2 | 141.6 ± 80 | 696.8 ± 126.1 | 735.8 ± 165.5 |
| (S)-(−)-limonene | | | | |
| Eucalyptol | <LOQ** | 799.2 ± 227.9 | <LOQ*** | 622.4 ± 134.4 |
| Ocimene | <LOQ** | 1101.1 ± 692.6 | <LOQ*** | 1389.2 ± 614.6 |
| Linalool | 554.1 ± 242.7* | 788 ± 237.1 | 169.4 ± 170.3 | 160.0 ± 149.1 |
| Nerol | 527.4 ± 1153.5 | 374.1 ± 898.8 | 80.4 ± 179.8 | 251.6 ± 394.9 |
| Geraniol | 296.9 ± 665.6 | 312.2 ± 709.4 | 64.2 ± 143.5 | 261.4 ± 443.1 |
| E,E-farnesol | <LOQ** | 1564 ± 1006 | <LOQ** | 1237.2 ± 609.1 |

Eucalyptol provoked the strongest response (Wilcoxon test, N=7 pairs, T=0, Z=2.366, df=12, p=0.017; FIG. 2a), showing that this terpene is the most potent component of the bumblebee food alerting pheromone. The test with individually marked foragers revealed that the entire forager force of the colony was activated by eucalyptol. The pre-test observations had revealed that the colony contained a total of 17 active foragers. In the 30 min prior to the insertion of eucalyptol, 4 foragers arrived at the feeder. After exposure of the colony to eucalyptol, the remaining 13 foragers arrived within 15 minutes (FIG. 2b). The effect of ocimene is also significant (Wilcoxon test, N=7 pairs, T=2, Z=2.03, df=12, p=0.042) whereas farnesol produced only a non-significant rise in activity (N=7 pairs, T=5, Z=1.52, df=12, p=0.128), and the solvent acetone yielded none (N=7 pairs, T=10, Z=0.105, df=12, p=0.91; FIG. 2a).

The results of these experiments identify eucalyptol as the main active ingredient of the bumblebee foraging alert pheromone. It is likely an optimum effect can only be created using a realistic mixture of other components of the tergal gland-produced pheromones, which also include ocimene and farnesol. However, the experiment with individually marked bees showed that the entire forager force of the colony can be activated with eucalyptol alone. Thus, it is not possible that a mixture of the identified compounds will produce recruitment of more foragers—but it is conceivable that they might be recruited more speedily. Previous tests showed that the recruitment effect produced by successful bumblebee foragers takes more than 30 min to build up (Dornhaus and Chittka 1999), whereas under the influence of eucalyptol, all foragers had left the colony within 15 minutes (FIG. 2b). Hence, eucalyptol alone produces at least as strong a response as actual bumblebee recruitment. The function of the other compounds remains unknown at this stage.

### REFERENCES

Dornhaus et al (2003) J Comp Physiol A 189: 47-51
Dornhaus A, & Chittka L (1999) Nature 401: 38
Dornhaus A, & Chittka L (2001) Behav Ecol Sociobiol 50:570-576
Free et al (1981) Physiol Entomol 6: 263-268
Mena Granero et al (2004) J Chromatogr A 1045: 173-179
Tautz J, & Rohrseitz K (1998) J Comp Physiol A 183:661-667

1. A method of pollination of a plant of an angiosperm plant species by an insect of the genus Bombus, comprising administering a composition comprising eucalyptol and/or ocimene and/or farnesol to an angiosperm plant in need of pollination, or administration of the composition to the environment of said plant to attract said insect.

2. The method of claim 1, wherein the composition is administered to the environment of an angiosperm plant in need of pollination.

3. The method as claimed in claim 1, in which the angiosperm plant species is selected from Tomato, courgette/zucchini, pumpkin/squash, cucumber, strawberries, egg plants/aubergine, melons, peppers, sweet peppers, blueberries, apricots, almonds, apples, cranberries, raspberries, red currant, black currant, cherry, peach, pear, and plum.

4. A method for attracting an insect of the genus Bombus to a plant of an angiosperm plant species, comprising administering a composition comprising eucalyptol and/or ocimene and/or farnesol to the plant or to the environment of the plant.

5. (canceled)

6. A method for causing an insect of the genus Bombus to leave a colony of said insects, comprising administration of a composition comprising eucalyptol and/or ocimene and/or farnesol to the colony.

7. The method of claim 1 comprising the separate, simultaneous or subsequent administration of eucalyptol, ocimene and farnesol to said plant.

8. The method as claimed in claim 1, in which the insect of the genus Bombus is a bumblebee of the species selected from the group consisting of Bombus terrestris, Bombus impatiens, Bombus occidentalis, Bombus canariensis, Bombus ignitus, Bombus hypocrite, and Bombus diversus.

9. The method as claimed in claim 3, in which the Tomato is Lypersicon esculentum, the courgette/zucchini is Cucurbita pepo, the pumpkin/squash is Curcurbita pepo, the cucumber is Cucumis sativus, the strawberries are Fragaria spec., the egg plants/aubergine are Solanum melongena, the melons are Cucumis melo, the peppers are Capsicum annuum, the sweet peppers are Capsicum annuum, the blueberries are Vaccinum myrtillus, the apricots are Prunus armeniaca, the almonds are Prunus dulcis, the apples are Malus domestica, the cranberries are Vaccinum vitis-idaea, the raspberries are Rubus idaeus, the red currant is Ribes rubrum, the black currant is Ribes nigrum, the cherry is Prunus spec., the peach is Prunus persica, the pear is Pyrus pyraster, and the plum is Prunus domestica.

10. The method as claimed in claim 4, in which the angiosperm plant species is selected from Tomato, courgette/zucchini, pumpkin/squash, cucumber, strawberries, egg plants/aubergine, melons, peppers, sweet peppers, blueberries, apricots, almonds, apples, cranberries, raspberries, red currant, black currant, cherry, peach, pear, and plum.

11. The method as claimed in claim 10, in which the Tomato is Lypersicon esculentum, the courgette/zucchini is Cucurbita pepo, the pumpkin/squash is Curcurbita pepo, the cucumber is Cucumis sativus, the strawberries are Fragaria spec., the egg plants/aubergine are Solanum melongena, the melons are Cucumis melo, the peppers are Capsicum annuum, the sweet peppers are Capsicum annuum, the blueberries are Vaccinum myrtillus, the apricots are Prunus armeniaca, the almonds are Prunus dulcis, the apples are Malus domestica, the cranberries are Vaccinum vitis-idaea, the raspberries are Rubus idaeus, the red currant is Ribes rubrum, the black currant is Ribes nigrum, the cherry is Prunus spec., the peach is Prunus persica, the pear is Pyrus pyraster, and the plum is Prunus domestica.

12. The method of claim 4 comprising the separate, simultaneous or subsequent administration of eucalyptol, ocimene and farnesol to said plant.

13. The method as claimed in claim 4, in which the insect of the genus Bombus is a bumblebee of the species selected from the group consisting of Bombus terrestris, Bombus impatiens, Bombus occidentalis, Bombus canariensis, Bombus ignitus, Bombus hypocrite, and Bombus diversus.

14. The method of claim 6 comprising the separate, simultaneous or subsequent administration of eucalyptol, ocimene and farnesol to said colony.

15. The method as claimed in claim 6, in which the insect of the genus Bombus is a bumblebee of the species selected from the group consisting of Bombus terrestris, Bombus impatiens, Bombus occidentalis, Bombus canariensis, Bombus ignitus, Bombus hypocrite, and Bombus diversus.
